(19) United States
(12) Patent Application Publication
(10) Pub. No.: US 2005/0171845 A1
(43) Pub. Date: Aug. 4, 2005

(54) System and method for delivering messages onto a sale register receipt

(75) Inventors: Tim Halfman, Schaumburg, IL (US); Brian Rock, Kildeer, IL (US); Mark Smith, West Hartford, CT (US)

Correspondence Address: BACHMAN & LAPOINTE, P.C., 900 CHAPEL STREET, SUITE 1201, NEW HAVEN, CT, 06510, US

(73) Assignee: POSNET SERVICES, LLC

(21) Appl. No.: 11/047,333

(22) Filed: Jan. 28, 2005

Related U.S. Application Data
(60) Provisional application No. 60/540,702, filed on Jan. 30, 2004.

(51) Int. Cl. G06F 17/60

(52) U.S. Cl. 705/14; 705/16

(57) ABSTRACT

A system is provided for delivering a message and/or offer to consumers at the POS terminal by communicating through electronic displays and/or printing the message and/or offer onto a customer receipt tape that shows the items, totals, and payment made during a shopping event. The message and/or offer communicated to the consumer is gathered from a database which contains a plurality of promotional materials including promotional messages, advertisement, discount coupons, and offers. The system provides the enabled retailers and offer distributors with the ability to send an offer communication for cents-off, discounts, and other promotional messages so that it can be displayed and/or printed directly onto the receipt tape itself through the point of sale (POS) terminal in use.

### CROSS-REFERENCE TO RELATED APPLICATIONS

The present application claims the benefit of U.S. provisional patent application Ser. No. 60/540,702, filed Jan. 30, 2004.

### BACKGROUND OF THE INVENTION

The present invention relates to the creation, delivery, and communication of information for marketing purposes to consumer/shopper's checkout receipt tapes, and in particular, to enhance the ability to offer discounts, cents off coupons, advertising, customer value status messages and communications of a general promotional nature on electronic and printed receipts with the messages and other information based upon offers in an offer registry and made available to retailers.

Presently, retailers use point of sale (POS) terminals which are capable of printing primarily messages or in limited situations, discount coupons to be used on a future purchase on receipt tapes. Present system's printing on the tape typically only offer text messages that are not tied to the purchase activity or customized to the shopper on the specific shopping trip. Present receipt messaging is not variable or specific to customer-purchase activity, or these systems offer non-transaction-unique messaging. Offers printed on receipts today are very limited to the retailer POS system preset programming and do not link to non-retailer, third party offer distributors or provide support to executing targeting strategies.

Thus, there is needed a system which overcomes these shortcomings.

### SUMMARY OF THE INVENTION

It is an object of the present invention to provide a system and method for delivering promotional materials, such as promotional messages, advertisements, discount offers, coupons and other promotional information, for marketing purposes to consumers at a point of sale (POS) terminal.

It is also a further object of the present invention to provide a technique for developing a database containing promotional materials to be distributed to consumers at POS terminals.

The foregoing objects are attained by the present invention.

In accordance with the present invention, a system for delivering promotional materials to consumers for marketing purposes is provided. The system broadly comprises a database containing at least one offer, at least one message, and at least one coupon, which database is stored on a storage device, means for creating communications between the database and a POS terminal, and means for selecting at least one of the at least one offer, the at least one message, and the at least one coupon based upon a transaction occurring at said POS terminal.

Also in accordance with the present invention, a method for providing information and offers to consumers is provided. The method broadly comprises the steps of compiling a database containing a plurality of offers, messages, and coupons, storing the database on a storage device, selecting at least one of the offers, the messages, and the coupons based upon a transaction occurring at a POS terminal, and forwarding the selected at least one of the offers, messages, and coupons to the POS terminal.

Other details of the system and method for delivery of messages onto a sale register receipt tape, as well as other objects and advantages attendant thereto, are set forth in the following detailed description and the accompanying drawings, wherein like reference numerals depict like elements.

### BRIEF DESCRIPTION OF THE DRAWINGS

FIG. 1 shows a system for receiving information about a customer purchase activity, the interaction with an offer registry, and the output of a message/information;

FIG. 2 is a flow chart depicting the display of information and/or messages to the customer;

FIG. 3 illustrates the printed output on a receipt; and

FIG. 4 is a schematic representation of a system in accordance with the present invention.

### DETAILED DESCRIPTION OF THE PREFERRED EMBODIMENT(S)

Purchase activity at the point of sale (POS) terminal in a store may be reviewed for customer identification, purchase activity by item, category, etc. All of the data from the review may be inputted or scanned by the POS terminal. This data may be processed by the system and each eligible offer or message may be made available to be communicated to the consumer via electronic means, such as on an electronic display at the POS terminal, or via print on the receipt tape at check out. The collected transaction data and information may be processed by the system 10 and the offer, discount coupons, and/or message outputs may be sent to the POS terminals for display and printing.

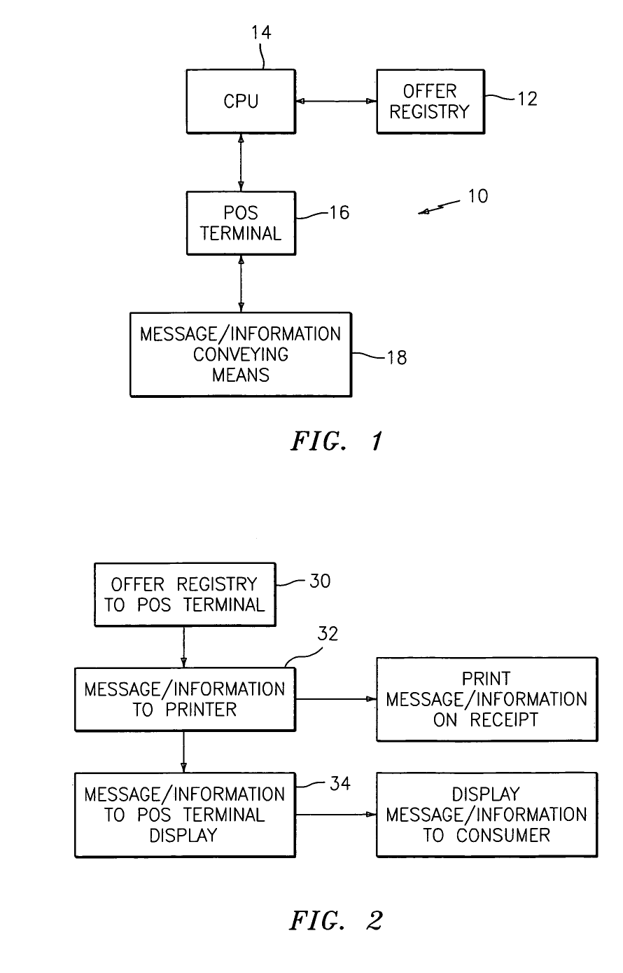

Referring now to the drawings, FIG. 1 illustrates a system 10 for providing promotional materials, such as informational messages, discount offers, coupons and the like, to consumers at a POS terminal 16. The system 10 may include an offer registry 12, which is preferably a database in which a plurality of offers, messages, coupons, and information to be made available to consumers may be kept. The offer registry 12 may comprise a central processing unit having a memory device associated therewith for storing the database. The central processing unit may be any suitable central processing unit known in the art and may be programmed to allow the database or offer registry to be modified in a desired manner by retailers, offer distributors, and other authorized users.

As shown in FIG. 1, the system 10 may further include a central processing unit 14 in the retail store which communicates with one or more POS terminals 16. The central processing unit 14 may be any suitable central processing unit known in the art and may be programmed in any suitable way. The central processing unit 14 may communicate with the offer registry 12 using any suitable connection means known in the art, such as modems and telephone lines. The central processing unit 14 may receive information about the consumer completing a transaction from the POS terminal 16 and may review the purchase activity of the consumer. The central processing unit 14 may have, within a memory, a series of offers, discount coupons, promotional messages and/or other information to be made available to a particular consumer who has made a purchase. Alternatively, after a consumer has been identified, the central processing unit 14 may transmit the consumer identification to the offer registry 12. Thereafter, the offer registry 12 may convey to the central processing unit 14, the information, the messages, the offers and/or the coupons to be conveyed to the consumer.

The POS terminal 16 shown in FIG. 1 may be any suitable POS terminal known in the art. As mentioned hereinbefore, the POS terminal 16 may be used to transmit consumer information and purchase activity to the central processing unit 14 using any suitable communication means known in the art. The POS terminal 16 preferably receives from the central processing unit 14, the messages, the discount coupons, the offers and/or other information to be conveyed to the consumer during the sales transaction, which messages, cents-off coupons, discount offers, and/or other information may include information about cents-off coupons and discount offers available to the consumer on either this purchase or future purchases.

The system 10 may further include means 18 for conveying the messages, the discount offers, the cents off coupons, and the information to the consumer. The information and message conveying means 18 may be a printer which prints a receipt tape to be given to the consumer at the POS terminal 16. Alternatively, or in addition thereto, the message and information conveying means 18 may be a display screen, such as an LED screen, a video screen, or an electronic display, which is visible to the consumer at the POS terminal 16.

FIG. 2 is a flow chart illustrating the conveyance of the messages, cents-off coupons, discount offers, and information to the consumer. In step 30, the offer registry 12 sends the available information, cents-off coupons, discount offers and/or messages to the POS terminal 16. In step 32, the information, cents-off coupons, discount offers and/or messages are conveyed to a printer at the terminal 16 so that the information, cents-off coupons, discount offers and/or messages are printed onto the register tape. In step 34, the information, cents-off coupons, discount offers, and/or messages may be conveyed to an electronic device, such as a pole or a display screen, for display to the consumer.

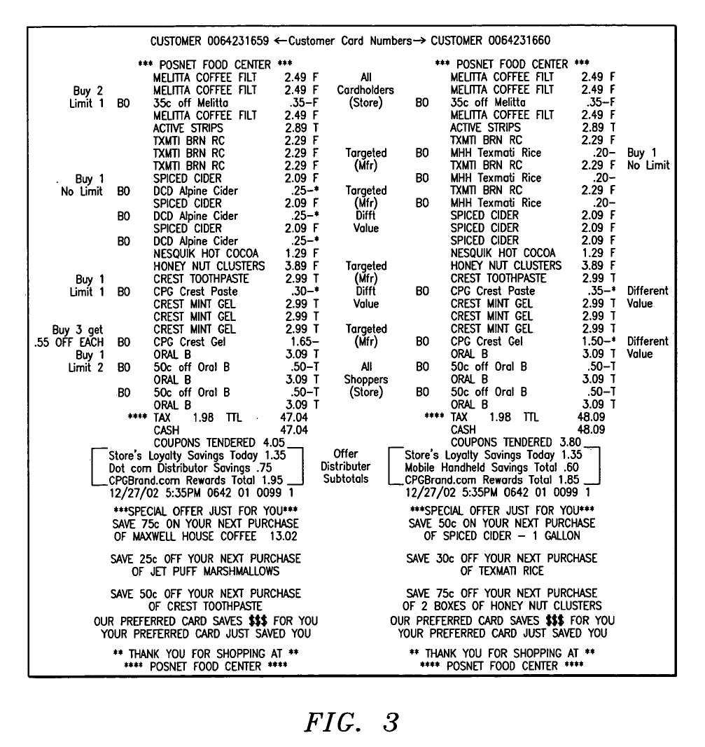

FIG. 3 illustrates a printed tape containing such promotional information, cents off coupons, discount offers, and/or messages.

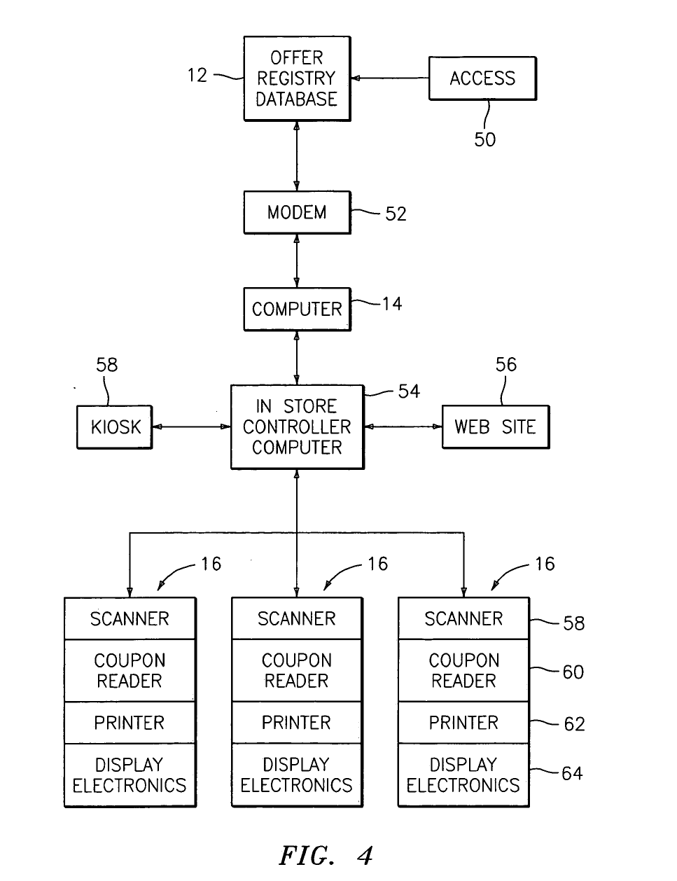

FIG. 4 illustrates an embodiment of an overall system 10 in accordance with the present invention. As previously indicated, the system 10 includes an offer registry 12. Access means 50 may be provided so that distributors, retailers, and other authorized users subscribing to the system 10 may input discount offers, cents-off coupons, messages, and/or other promotional information to be made available to consumers into the offer registry 12. As previously discussed, the offer registry 12 may communicate with an in-store central processing unit 14 via a modem 52. The in-store central processing unit 14 in turn may communicate with an in-store computer 54 which controls one or more POS terminal(s) 16. If desired, the in-store computer 54 may communicate with a web site 56 and/or one or more in-store kiosks 58 operated by the retailer or some other customer messaging entity.

Each POS terminal 16 may include a scanner 58 for scanning the products being purchased, a coupon authorization device 60 for validating coupons, a printer 62 for printing a receipt tape, and electronic means 64 for displaying information and/or messages on a pole or a display screen.

The system 10 of the present invention is quite advantageous in that it enables offer distributors and appropriate system participants to conveniently offer consumers a promotional message, other promotional information, cents-off coupons and/or discount offers printed on receipt tapes or otherwise displayed at the POS terminal as the offer was intended, for example, by a consumer packaged goods manufacturer and delivered by the system. The ability to deliver the printed message through an existing offer registry system's infrastructure increases the potential customer reach for promotional offers to each retailer's and/or advertiser's specific consumers, unlike traditional promotional methods. The greater reach is made possible by the use of the system's ability to review each transaction activity and to process it via the offer registry and database. The offers and other promotional materials to be delivered may be targeted if desired.

Printing the message(s) and/or information directly on the register receipt reinforces the actual and perceived value of the retailer and promoted item(s) to the consumer.

The system of the present invention provides the system participants, distributors, CPG manufacturers, and retailers with an ability to send a message to be printed on the customer's current shopping trip receipt tape. The offer(s) appear as messages that communicate a promotional incentive. The promotional incentive is one that may be acted upon during a subsequent shopping event for the consumer at the present retail location or other location(s) of the participants using the system.

The system 10 creates the messages and delivers them as directed through an offer management system, namely the offer registry 12. Printing a message that is targeted and/or a very unique message on a register or receipt tape for each shopper is an important goal for offer distributors. Presenting unique and/or targeted offers provides a special incentive for the next trip and makes the offer special to the shopper. Also, marketing strategies are easily detected or easily known and copied by a competitor. Having the ability to motivate the return of a customer to a retail location for another purchase is very desirable. Return incentives are an important marketing tool for retailers, offer distributors and their advertising customers. The system of the present invention has an offer registry that allows many offer distributors to communicate with customers at the POS check out and on the receipt tape. The offers may be targeted to specific definable consumers (defined through the offer registry) and may be based upon their credit card or loyalty program number. The offer registry and targeting features permit purchase item level targeting of products or items not present to be targeted for a promotional message or offer.

The targeted offers may be tracked by the system 10 according to the source of issuance, the point of valid redemption, and all other relevant transactional data elements. The system permits each offer issuer the ability to send a brand specific message to a customer meeting the requirements for the incentive offer. The system validates specific product purchase requirements of the offer and assures compliance to the terms with the customer. This may be done without the need for merchant's intervention or cooperation.

The promotional message(s) may be displayed on the POS terminal's message display pole, as text or graphics. The text and content may be built on the fly. The message pole may prompt a consumer to look at the receipt tape for more offers.

The targeting of the message or offer may be a function of what has been set up in the offer registry, sending a message based upon definable attributes from data fields or set as a random offer, total dollars spent, cumulative or in some measurable fashion and/or by specific customer ID, location, time of day, etc. An offer on the tape may include a bar code or machine readable code to identify the offer/transaction when redeemed or presented for discount.

Specific registry offers may be able to be delivered based upon categories, PLU's, and in any manner that the database within the offer registry is able to communicate and identify eligible offer conditions from the POS terminal activity.

It is apparent that there has been provided in accordance with the present invention a system and method for delivering messages onto a sale register receipt tape which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace such alternatives, modifications, and variations as fall within the broad scope of the appended claims.

1. A system for delivering promotional materials to consumers for marketing purposes comprising:
a database containing at least one offer, at least one message, and at least one coupon;
said database being stored on a storage device;
means for creating communications between said database and a POS terminal; and
means for selecting at least one of said at least one offer, said at least one message, and said at least one coupon based upon a transaction occurring at said POS terminal.

2. A system according to claim 1 wherein said database contains a plurality of offers, messages, and coupons.

3. A system according to claim 2, wherein said messages include promotional messages and advertising messages.

4. A system according to claim 1, further comprising means for distributors to gain access to said database to change information stored on said database.

5. A system according to claim 1, further comprising means for retailers to gain access to said database to change information stored on said database.

6. A system according to claim 1, further comprising means for authorized users to gain access to said database to change information stored on said database.

7. A system according to claim 1, further comprising means for electronically displaying said selected at least one of said at least one offer, said at least one message, and said at least one coupon at said POS terminal.

8. A system according to claim 7, wherein said electronic display means comprises a display screen visible to said consumer.

9. A system according to claim 1, further comprising means for printing said selected at least one of said at least one offer, said at least one message, and said at least one coupon on a paper document to be provided to said consumer.

10. A system according to claim 9, wherein said printing means comprises means for printing said selected at least one of said at least one offer, said at least one message and said at least one coupon on a customer receipt tape showing items, totals, and payment made during a shopping event.

11. A system according to claim 1, wherein said selecting means comprises means for selecting said at least one of said at least one offer, said at least one message, and said at least one coupon based upon consumer identity.

12. A system according to claim 1, wherein said selecting means comprises means for selecting said at least one of said offer, message, and said coupon based upon at least one purchased item.

13. A system according to claim 1, further comprising means for collecting transactional data.

14. A system according to claim 1, wherein said storage device comprises a central processing unit having a memory device associated therewith.

15. The system according to claim 1, wherein said communications creating means includes a central processing unit in a location remote from said database.

16. The system according to claim 15, wherein said remote central processing unit comprises a central processing unit in a retail store connected to said POS terminal.

17. The system according to claim 16, wherein said database communicates said selected at least one of said at least one offer, said at least one message, and said at least one coupon to said central processing unit in said retail store.

18. The system according to claim 16, wherein said central processing unit communicates with an in-store computer which controls said POS terminal.

19. The system according to claim 18, wherein said in-store computer communicates with a web site.

20. The system according to claim 18, wherein said in store-computer communicates with an in-store kiosk.

21. The system according to claim 1, wherein said POS terminal includes a scanner, means for validating coupons, a printer for generating a receipt tape, and electronic means for displaying at least one of information and messages.

22. A method for providing information and offers to consumers comprising the steps of:
compiling a database containing a plurality of offers, messages, and coupons;
storing said database on a storage device;
selecting at least one of said offers, said messages, and said coupons based upon a transaction occurring at a POS terminal; and
forwarding said selected at least one of said offers, messages, and coupons to said POS terminal.

23. The method according to claim 22, further comprising displaying said selected at least one of said offers, messages and coupons at said POS terminal.

24. The method according to claim 23, wherein said displaying step comprises displaying said selected at least one of said offers, messages and coupons on a visual display which can be seen by a consumer.

25. The method according to claim 23, wherein said displaying step comprises printing said selected at least one of said offers, messages and coupons on a printed document to be given to said consumer.

26. The method according to claim 23, wherein said displaying step comprises printing said selected at least one of said offers, messages and coupons on a receipt tape to be given to said consumer

27. The method according to claim 22, further comprising accessing said database to modify contents of said database.

28. The method according to claim 22, wherein said selecting step comprises forwarding information to said database about the consumer completing a transaction and reviewing consumer purchase activity.
